(19) United States
(12) Patent Application Publication
(10) Pub. No.: US 2006/0102810 A1
(43) Pub. Date: May 18, 2006

(54) Hands-free baby bottle holder

(76) Inventor: Sabrina Banks, Dunwoody, GA (US)

Correspondence Address: DOUGHERTY CLEMENTS, 1901 ROXBOROUGH ROAD, SUITE 300, CHARLOTTE, NC, 28211, US

(21) Appl. No.: 11/271,348

(22) Filed: Nov. 12, 2005

Related U.S. Application Data
(60) Provisional application No. 60/628,669, filed on Nov. 18, 2004.

(51) Int. Cl. A61J 9/06; A47D 15/00

(52) U.S. Cl. 248/102

(57) ABSTRACT

The present invention provides a hands-free baby bottle holding device used in order to eliminate the need for a caregiver to an infant to constantly hold a baby bottle while the infant is nursing a liquid. The hands-free baby bottle holder is comprised of: a foam block having a base support, a base upper edge, a right side support, a right side interior edge, a left side support, a left side interior edge, and a multitude of rounded edges; a bottle channel, to support and hold a baby bottle and baby bottle nipple; an outer fabric covering; a toy attachment tab; and a stuffed toy.

### CLAIM TO PRIORITY

Applicant hereby claims priority under all rights to which she is entitled under the benefit under 35 USC 119(e) based upon the U.S. Provisional Application Ser. No. 60/628,669 for this patent application filed at the United States Patent and Trademark Office on Nov. 18, 2004.

### FIELD OF THE INVENTION

The present invention relates generally to the field of infant feeding devices. More specifically the present invention relates to a hands-free baby bottle holding device used in order to eliminate the need for a caregiver to an infant to constantly hold a baby bottle while the infant is nursing a liquid.

### BACKGROUND OF THE INVENTION

Since an infant lacks the ability to coordinate the movement of his arms and hands in a manner such that he can hold or manipulate an infant feeding bottle, the aid of a caregiver generally is needed. This requires that the caregiver remain with the infant at all times while the infant is nursing from the bottle. While providing such care to an infant is an enjoyable and rewarding experience, times exist in which the caregiver must step away for a moment and leave the infant without direct feeding assistance. Under such circumstances the infant likely is unable to hold or manipulate an infant feeding bottle alone. Furthermore, circumstances may exist under which a caregiver cannot simultaneously provide a bottle to multiple infants. For example, consider the mother of children from a multiple birth. It is difficult, if not impossible, to simultaneously bottle feed more than one child while still holding each bottle by hand.

In the prior art, many devices have been disclosed for positioning baby bottles such that a baby bottle filled with liquid may be placed near an infant, and a caregiver to the infant may have both hands free to perform other tasks while the infant is nursing from the bottle. Many such devices still require that the infant grasp the bottle or its associated holding device in order to remain attached to the nipple of the bottle. Still other devices are either cumbersome or manufactured of a hard material, potentially unsafe for an infant.

However, while such devices may be suitable for their particular purposes, they are not suitable for the purposes of the present invention. Therefore, a need exists for a hands-free baby bottle holder that enables an infant to nurse a bottle without the immediate presence and hands-on attention of a caregiver.

These and other problems exist. Previous attempts to solve these and other problems include the following:

U.S. Pat. No. 3,584,818, issued to Essman on Jun. 15, 1971, discloses a baby bottle holder formed from a block of polyurethane foam-type material which simultaneously retains the bottle in position for a nursing baby and therefore insulates the bottle to maintain the milk or other food product contained with the bottle at a relatively constant temperature.

U.S. Pat. No. 2,134,746, issued to Allen on Nov. 1, 1938, discloses a bottle holder to retain a nursing bottle in any angular position for use when an infant is lying down or in a sitting position.

U.S. Pat. No. 4,227,270, issued to Rivera on Oct. 14, 1980, discloses a pillow case having a receptacle upon its upper side in which a baby bottle is retained during the time of nursing, and the pillow case upper side includes a sideward extending flap upon which a baby rests its head while sucking on the bottle nipple.

U.S. Design Pat. No. D. 361,131, issued to Leopold on Aug. 8, 1995, discloses an ornamental design for a bottle support.

U.S. Design Pat. No. D. 363,549, issued to Ye on Oct. 24, 1995, discloses an ornamental design for a nursing bottle support.

U.S. Design Pat. No. D. 439,671, issued to Casillo et al. on Mar. 27, 2001, discloses an ornamental design for a baby bottle holder.

U.S. Pat. No. 2,510,953, issued to Brose on Aug. 6, 1947, discloses a nursing bottle holder adapted for use by young babies throughout all or most of the nursing period. It combines in itself a means for holding a bottle while a baby is lying on its side, and also a means for suspending a bottle when the baby is lying on its back.

U.S. Pat. No. 530,434, issued to Lowerre on Dec. 4, 1894, discloses a nursing-bottle holder or support capable of carrying the bottle in the natural position in which it is customarily held by hand so that the nipple on the bottle may be kept in proximity to the child's mouth and readily accessible.

U.S. Pat. No. 6,523,793, issued to Higgins on Feb. 25, 2003, discloses an infant feeding device for hands-free feeding of an infant. The device has a knee support cushion, a body and head support cushion, and a bottle support cushion. The cushions are secured onto a mat having fastening strips. The positioning of the cushions may be adjusted to accommodate the length of the infant. The bottle support cushion is an arch that extends over the infant's body and holds a bottle in place for feeding the infant.

U.S. Pat. No. 4,726,551, issued to Randall et al. on Feb. 23, 1988, discloses a baby bottle holder which enables a baby to feed from a bottle unassisted. Primarily, it consists of a pillow with a body wrap attached that includes flaps for securing it to the baby. It also includes a bottle holder block attached to one flap, which is provided with an elastic strap that holds and retains the baby bottle.

U.S. Pat. No. 5,217,192, issued to Oktayuren on Jun. 8, 1993, discloses a baby bottle holder to hold a baby bottle for an infant who cannot hold the bottle himself or herself. The design is such that the end which corresponds to the nipple end of the bottle is narrower than the end which corresponds to the bottom of the bottle. In addition, the holder is constructed and balanced in such a manner that the holder is freestanding whether or not a bottle is attached. The bottle is firmly grasped but is slidably mounted so that it may be repositioned for balance. Three members of the bottle holder are joined together so that the bottle position may be changed depending on the position of the baby.

U.S. Pat. No. 5,072,843, issued to James on Dec. 17, 1991, discloses a holder for holding a generally cylindrical bottle having an open end and a closed end which comprises a soft, cuddly, plush support member including a body having front and back surfaces forming a three dimensional figure suitable for amusing an infant.

U.S. Pat. No. 6,824,112, issued to Lange on Nov. 30, 2004, discloses a baby bottle holder that includes a stuffed toy body and a sleeve extending through the stuffed toy body to form at least one opening in the stuffed toy body.

U.S. Pat. No. 6,082,681, issued to Rand on Jul. 4, 2000, discloses a baby bottle holder for holding a baby bottle within ready access of a feeding infant. The bottle holder includes a bottle support that stably and securely holds a baby bottle, a cover that encloses the bottle support, and a strap for securely attaching the baby bottle holder to a horizontal support member. The baby bottle holder retains a baby bottle at an angle that facilitates the flow of a liquid nutrient within the bottle towards an outlet defined by the bottle wall. The cover can be removable and washable, and is in the shape of an animate object, preferably a cow.

U.S. Pat. No. 2,711,052, issued to Brayford on Jun. 21, 1955, discloses a combined doll and nursing bottle holder.

Additionally, there are several products in the market that seek to aid the caregiver of an infant with a feeding device or baby bottle holder. Among those are: the “Baby Bottle Cradle”, found online at http://www.babybottlecradle.com/instructions.htm; a product entitled the “Milk Maid Baby Bottle Holder”, found online at http://www.greatbabyproducts.com/Milk_Maid_Baby_Bottle_Holder_p/prod-mm220.htm; the “Bottle Genie”, found online at http://www.bottlegenieinc.com/; the “Bababib”, a bottle-holding bib, found online at http://www.bababib.com/; a bottle holder, which still requires an infant to grasp the holder, found online at http://www.litaf.com/web/inner.asp?cat=gallery&catld=4&info=22; the “Bottle Prop”, found online at http://store.yahoo.com/leachco/keepitup.html; and The EZ Baby “Baby Bottle Holder”, found online at http://www.babybottleholder.com.

Still other related infant feeding accessory products are available. For example, there are various devices which extend a baby bottle nipple to allow the baby bottle to be used by an infant in an upright position. These products include the “Pacifeeder”, found online at http://www.pacifeeder.com/ and the “podee”, found online at http://www.podee.corn/main.html. Additionally, related products include the “Bottle Keeper”, found online at http://www.mommyshelperinc.com/bottlekeeper.htm, a bottle-tethering device, and the “Bottle Sling”, found online at http://www.bottlesling.com/.

While these patents and other previous devices and methods have attempted to solve the above mentioned problems, none have provided for a hands-free baby bottle holder which would enable hands-free bottle feeding of an infant in the same safe and comfortable manner as the present invention. Therefore, a need exists for such a device and method of use.

### BRIEF SUMMARY OF THE INVENTION

In various embodiments, the present invention provides a new and useful hands-free baby bottle holder. A hands-free baby bottle holder is used in order to eliminate the need for a caregiver to an infant to constantly hold a baby bottle while the infant is nursing a liquid from the bottle.

In one exemplary embodiment, the present invention discloses a hands-free baby bottle comprised of a foam block having a base support, a base upper edge, a right side support, a right side interior edge, a left side support, a left side interior edge, and a multitude of rounded edges; a bottle channel, to support and hold a baby bottle and baby bottle nipple; an outer fabric covering; a toy attachment tab; and a stuffed toy.

In another exemplary embodiment of the present invention, the hands-free baby bottle holder further comprises a means by which music may be played at the push of a button located on the foam block. A soft button could be placed on the right side support or left side support of the foam block, such that it is also visible through the outer fabric covering. The button could then connect to internal electronics located in the base support of the foam block. Depressing the button would result in music being played. For example, the music might be a soft lullaby that would be soothing and calming to an infant.

A primary advantage of the present invention is that the hands-free baby bottle holder may be used to allow a baby to nurse a liquid from a baby bottle without the direct aid of a caregiver. While this invention is certainly no replacement for the immediate care of a human caregiver, the invention does provide for the independent and hands-free feeding of the infant and eliminates the need for a caregiver to an infant to constantly hold a baby bottle while the infant is nursing a liquid.

Another advantage of the present invention is that the hands-free baby bottle holder does not sit or ride upon the infant. Many devices in the background art rest upon the infant. This could be unsafe or uncomfortable.

Another advantage of the present invention is that the hands-free baby bottle holder easily may be used by the mother of children from a multiple birth where the need arises to simultaneously feed multiple infants. Either just one hands-free baby bottle holder may be used with a baby bottle placed at each end of the bottle channel to accommodate two children, or multiple hands-free baby bottle holders may be used to accommodate any number of infants.

Yet another advantage of the present invention is that the hands-free baby bottle holder easily may be used by those who are not necessarily infants. For example, the hands-free baby bottle holder may be used by adults with disabilities or older children who are bedridden.

### BRIEF DESCRIPTION OF THE DRAWINGS

The present invention is illustrated and described herein with reference to preferred embodiments and examples thereof, in which like reference numbers denote like parts or components, and in which:

FIG. 1 is a front perspective view of a hands-free baby bottle holder according to an embodiment of the present invention;

FIG. 2 is a front perspective view of a hands-free baby bottle holder according to an embodiment of the present invention;

FIG. 3 is a rear perspective view of a hands-free baby bottle holder according to an embodiment of the present invention;

FIG. 4 is a front perspective view of a foam block used in the hands-free baby bottle holder according to an embodiment of the present invention;

FIG. 5 is a front planar view of a foam block used in the hands-free baby bottle holder according to an embodiment of the present invention;

FIG. 6 is a rear planar view of a foam block used in the hands-free baby bottle holder according to an embodiment of the present invention;

FIG. 7 is a right side sectional view of a foam block used in the hands-free baby bottle holder according to an embodiment of the present invention; and

FIG. 8 is a top sectional view of a foam block used in the hands-free baby bottle holder according to an embodiment of the present invention.

### DETAILED DESCRIPTION OF THE INVENTION

Before explaining the disclosed embodiments of the present invention in detail, it is to be understood that the invention is not limited in its application to the details of the particular arrangement shown since the invention is capable of other embodiments. Also, the terminology used herein is for the purpose of description and not of limitation.

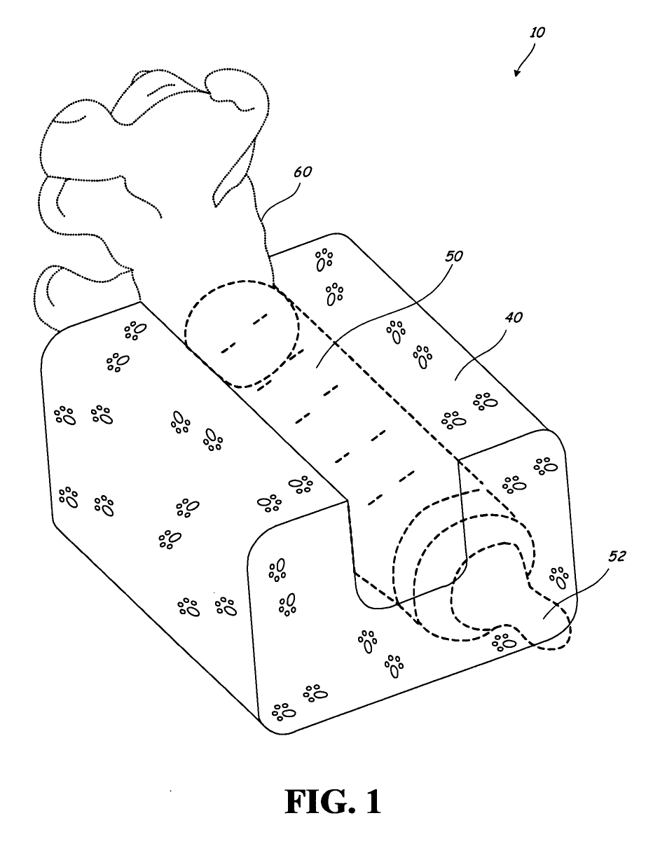

Referring now to FIG. 1, a front perspective view of a hands-free baby bottle holder 10 is shown. The hands-free baby bottle holder 10 is shown with a baby bottle 50, a baby bottle nipple 52, an outer fabric covering 40, and a stuffed toy 60. The baby bottle 50 used in the hands-free baby bottle holder 10 may be one of many currently available in the marketplace. The bottle channel of the foam block is sized such that it will accommodate standard baby bottle sizes. The stuffed toy 60 may be one of any of a variety of stuffed toys or stuffed animals that are of an appropriate size to fit in the hands-free baby bottle holder 10 at one end of the bottle channel. For example, the stuffed toy 60 may be a small stuffed teddy bear or other animal. The outer fabric covering 40 is placed over the foam block in its entirety, fitting closely to all of the edges of the foam block. The outer fabric covering 40 is made of a soft material such that any contact with an infant does not disturb the infant. The outer fabric covering 40 is easily removable for the purposes of washing and cleaning or to select another material design. The outer fabric covering 40 is illustrated with an animal footprint pattern suitable for infants. The hands-free baby bottle holder 10 holds the baby bottle 50 and its baby bottle nipple 52 at an angle such that an infant may lie beside the hands-free baby bottle holder 10 and nurse a liquid from the baby bottle 50.

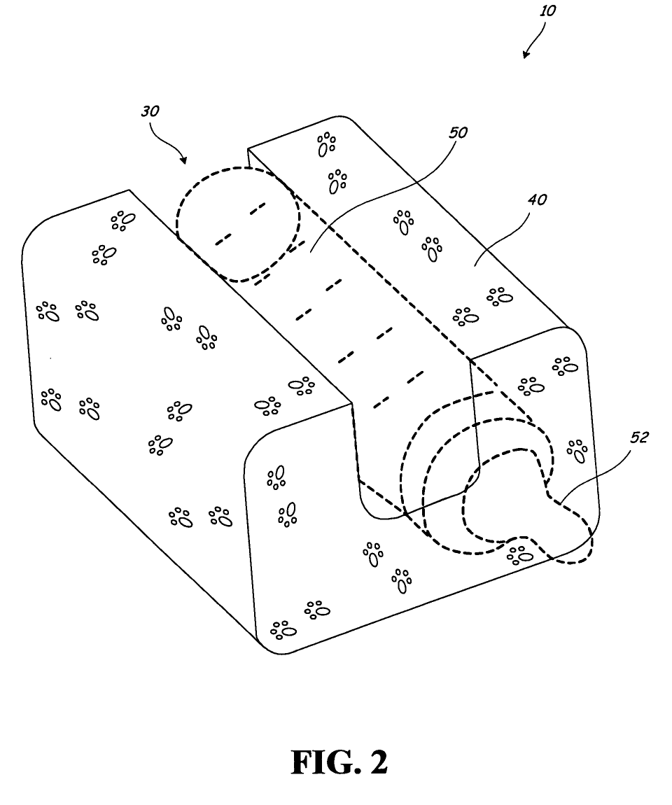

Referring now to FIG. 2, a front perspective view of a hands-free baby bottle holder 10 is shown. The hands-free baby bottle holder 10 is shown with a baby bottle 50, a baby bottle nipple 52, an outer fabric covering 40, and a bottle channel 30. The bottle channel 30 is the location in which a baby bottle 50 and/or stuffed toy is placed in the hands-free baby bottle holder 10. The bottle channel 30 is the vacant space created between the right side support and the left side support on the sides, and the base support on the bottom, of the foam block. The dimensions of the bottle channel 30 are such that a baby bottle fits snuggly and securely.

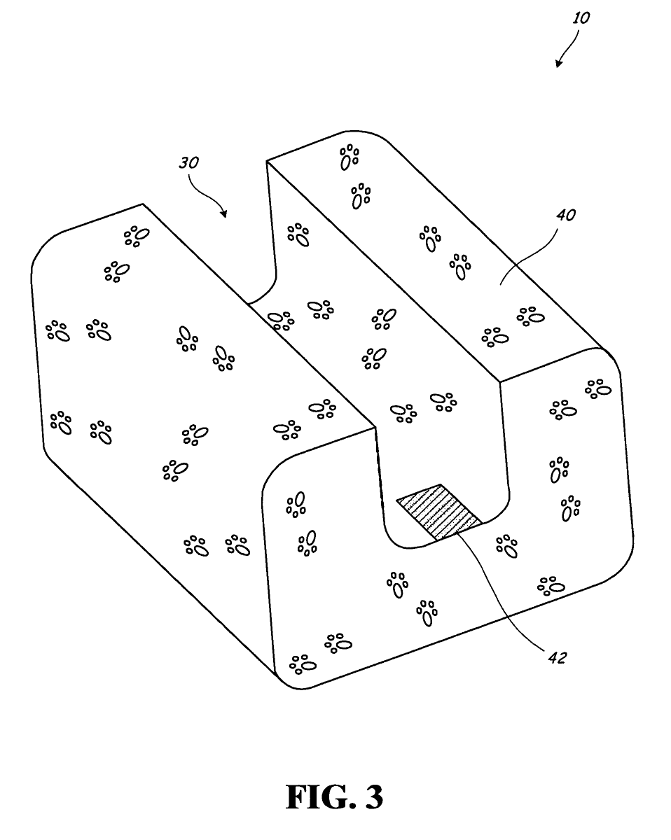

Referring now to FIG. 3, a rear perspective view of a hands-free baby bottle holder 10 is shown. The hands-free baby bottle holder 10 is shown with an outer fabric covering 40, a toy attachment tab 42, and a bottle channel 30. The toy attachment tab 42 is placed on outer fabric covering 40 above the top of the foam block and at one end of the bottle channel 30. The toy attachment tab 42 is used as an aid to assist in keeping a stuffed toy securely located in the bottle channel 30. The toy attachment tab 42 in this drawing is a Velcro(& brand hook and loop type fastener, such that one side of the fastener, either the hook side or the loop side, is placed on the stuffed toy and the other side is placed in the hands-free baby bottle holder 10 at one end of the bottle channel 30. The toy attachment tab 30 may also be another product other than Velcro(O so long as it securely holds a stuffed toy in the hands free baby bottle holder 10, yet at the same time allows for an infant, or caregiver to an infant, to easily remove the stuffed toy.

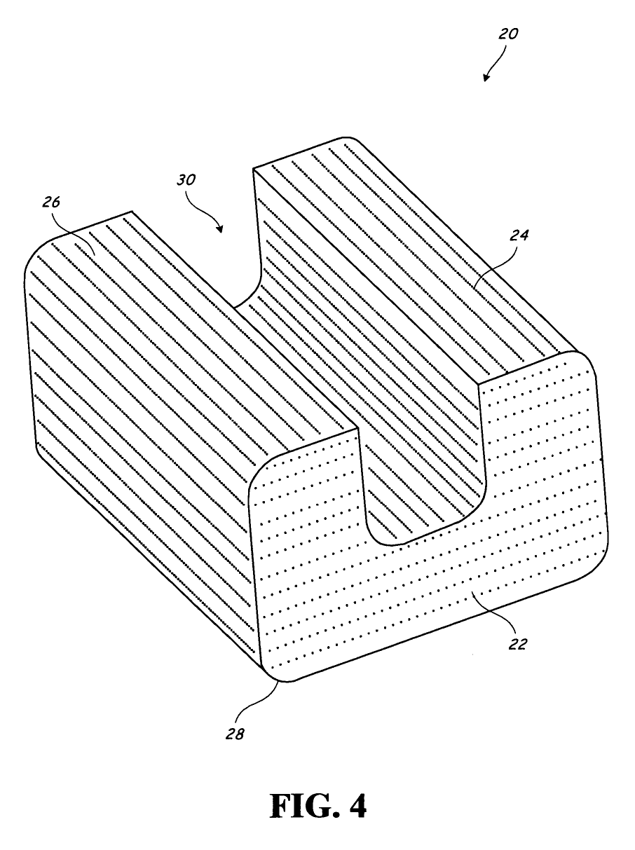

Referring now to FIG. 4, a front perspective view of a foam block 20 used in the hands-free baby bottle holder is shown. The foam block 20 is shown with the right side support 24, left side support 26, and the base support 22 that together form the foam block 20. The foam block 20 is additionally shown with the bottle channel 30 and the rounded edges 28 that are found on most edges and corners of the foam block 20. The foam block 20 shown here as used in the hands-free baby bottle holder is manufactured, shaped, and cut from Reflex™ polymer cushioning; however, other products such as flexible polyurethane foam or closed cell foam, among other types, may be used. The foam block 20 is additionally fire retardant. The Reflex™ polymer cushioning provides a comfortable and durable base support 22, right side support 24, and left side support 26 with which to securely hold a baby bottle in such a position that an infant can easily lie beside the device and nurse a liquid from the baby bottle. This foam block 20 will neither significantly sag nor go flat after use. Such a foam block 20 further provides resilience and pressure distribution. The base support 22 provides the foundational base that is placed on a flat surface and provides support for the foam block 20 as a whole. The left side support 26 and right side support 24 comprise the sides of the foam block 20 and provide support and the necessary tension with which to hold a baby bottle. The right-side interior edge and the left-side interior edge, together with the top portion of the base support, create a bottle channel 30, in which one or two bottles may be placed, or in which one bottle and one stuffed toy may be placed. Most of the corners and edges portions of these components are rounded, such the rounded edges 28 make the hands-free baby bottle holder less rigid and more convenient for the nearby infant who desires to get close to reach the baby bottle. The foam block 20 shown is made in the following approximate dimensions: a height of three and half inches, a length of six inches, and a width of five inches. Within the foam block 20, the base support 22 may be a height of one and half inches, a length of six inches, and a width of five inches. Placed upon the base support 22 are the right side support 24 and the left side support 26, each a height of two inches, a width of one and five eighths inches, and a length of six inches. The resultant bottle channel 30 created between the right side support 24 and the left side support 26 on the sides, and the base support 22 on the bottom, has the following approximate dimensions: a height of two inches, a width of one and three quarter inches, and a length of six inches. These dimensions illustrate only one possible size configuration of the foam block 20. Various other dimensions may be used such that the resultant bottle channel 30 has a sufficient size to snuggly and securely hold a baby bottle and a stuffed toy. For example, the overall length may be increased one or two inches to accommodate a larger baby bottle or two baby bottles at once.

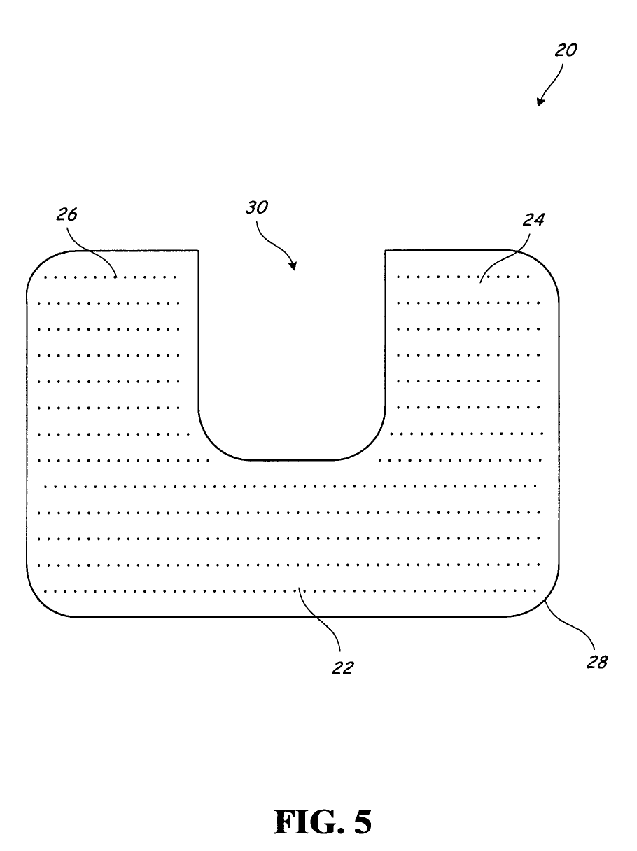

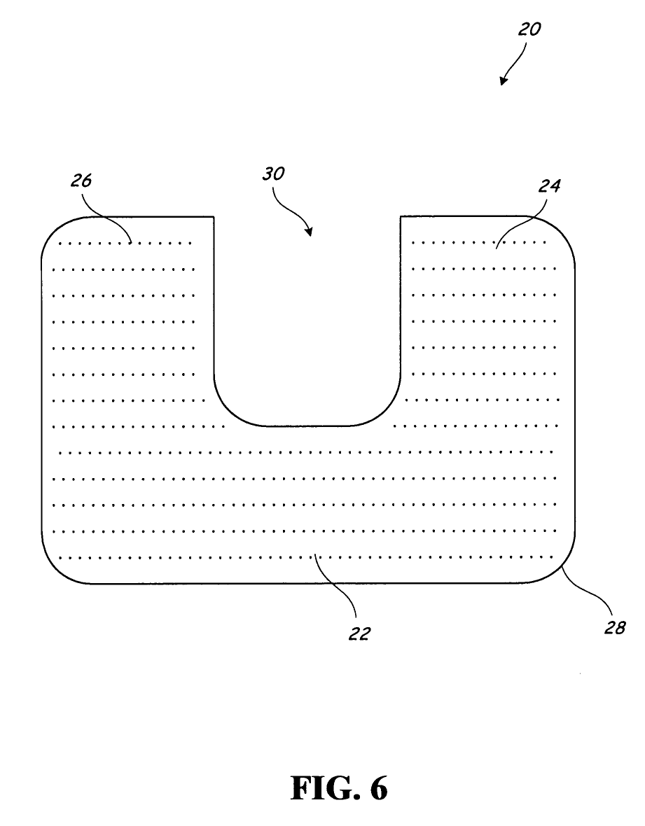

Referring now to FIGS. 5 and 6, a front planar view and a rear planar view of a foam block 20 used in the hands-free baby bottle holder are shown respectively. The foam block 20 is shown with the right side support 24, left side support 26, and the base support 22 that together form the foam block 20. The foam block is additionally shown with the bottle channel 30 and the rounded edges 28 that are found on most edges and corners of the foam block 20.

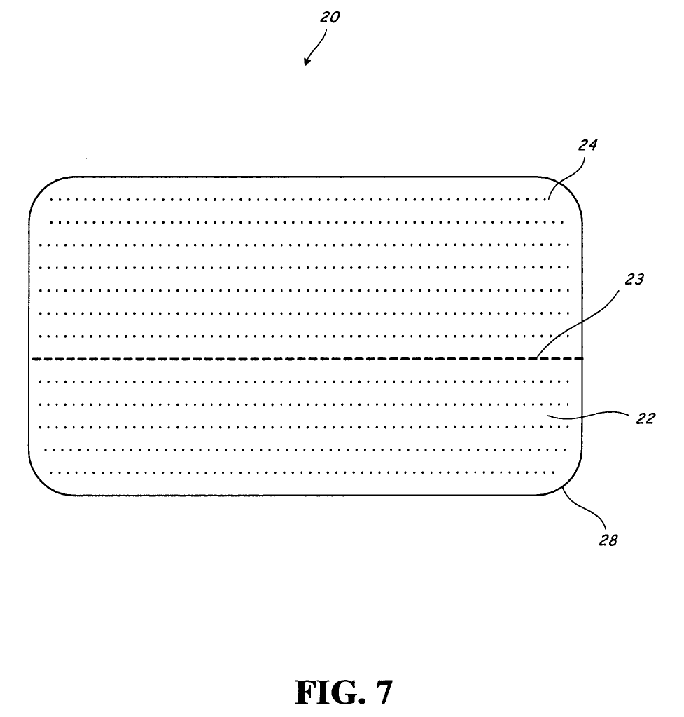

Referring now to FIG. 7, a right side sectional view of a foam block 20 used in the hands-free baby bottle holder is shown. The side, sectional view of the foam block 20 is also shown with the right side support 24, the base support 22, the base upper edge 23, and rounded edges 28. The foam block 20 shown is constructed with a height of three and half inches, a length of six inches, and a width of five inches. Within the foam block 20, the base support 22 is shown with a height of one and half inches, a length of six inches, and a width of five inches. The right side support 24 is placed upon the base support 22 at the base upper edge 23. The right side support 24 shown is a height of two inches, a width of one and five eighths inches, and a length of six inches.

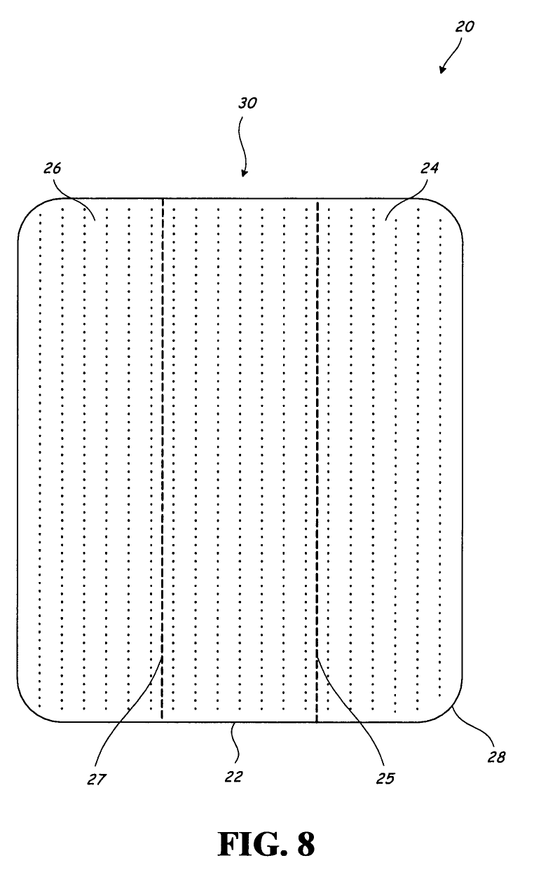

Referring now to FIG. 8, a top sectional view of a foam block 20 used in the hands-free baby bottle holder is shown. The top sectional view of a foam block 20 is also shown with the bottle channel 30, the right side support 24, the left side support 26, the base support 22, rounded edges 28, the left side interior edge 27, and the right side interior edge 25. The foam block 20 shown is constructed with a height of three and half inches, a length of six inches, and a width of five inches. The right side support 24 and the left side support 26 each is shown with a width of one and five eighths inches and a length of six inches. The vacant area between the right side support 24 and the left side support 26 and above the base support 22 is the bottle channel 30. The bottle channel 30 created between the right side support 24 and the left side support 24 on the sides and the base support 22 on the bottom has the following approximate dimensions: a height of two inches, a width of one and three quarter inches, and a length of six inches.

Although the present invention has been illustrated and described with reference to preferred embodiments and examples thereof, it will be readily apparent to those of ordinary skill in the art that other embodiments and examples may perform similar functions and/or achieve similar results. For example, the dimensions pertaining to the foam block 20 may be manufactured with a greater length in order to accommodate larger or multiple bottles. Likewise, any suitable materials may be used for the hands-free baby bottle holder 10 so long as the product as a whole remains fire retardant and can securely hold a baby bottle 50 such that an infant can easily nurse a liquid from the baby bottle 50. All such equivalent embodiments and examples are within the spirit and scope of the invention and are intended to be covered by the following claims.

What is claimed is:

1. A hands-free baby bottle holder for the hands-free feeding of an infant, comprising:
a foam block having:
a base support;
a base upper edge;
a right side support;
a right side interior edge;
a left side support;
a left side interior edge; and
a multitude of rounded edges;
a bottle channel, to support and hold a baby bottle and baby bottle nipple;
an outer fabric covering;
a toy attachment tab; and
a stuffed toy.

2. The hands-free baby bottle holder of claim 1, wherein the foam block is comprised of flexible polyurethane foam.

3. The hands-free baby bottle holder of claim 1, wherein the foam block is comprised of closed cell foam.

4. The hands-free baby bottle holder of claim 1, wherein the foam block is comprised of Reflex™ polymer cushioning.

5. The hands-free baby bottle holder of claim 1, wherein the toy attachment tab is a hook and loop type fastener, with which a stuffed toy may be securely attached at an end of the bottle channel.

6. The hands-free baby bottle holder of claim 1, wherein the outer fabric covering is fleece.

7. The hands-free baby bottle holder of claim 1, further comprising a means for providing music.

8. A method of feeding an infant with a hands-free baby bottle holder, the hands-free baby bottle being comprised of:
a foam block having:
a base support;
a base upper edge;
a right side support;
a right side interior edge;
a left side support;
a left side interior edge; and
a multitude of rounded edges;
a bottle channel, to support and hold a baby bottle and baby bottle nipple;
an outer fabric covering;
a toy attachment tab; and
a stuffed toy;
comprising the steps of:
placing the hands-free baby bottle holder on a flat surface for the infant;
filling the baby bottle with a desired liquid;
securing the baby bottle nipple onto the baby bottle;
placing the baby bottle into the bottle channel at a desired angle;
adjusting the angle of the baby bottle as needed for an infant; and
placing the infant near the baby bottle nipple, such that the infant can nurse a liquid from the baby bottle.
